(19) United States
(12) Patent Application Publication
(10) Pub. No.: US 2014/0368337 A1
(43) Pub. Date: Dec. 18, 2014

(54) SYSTEM AND METHOD FOR PROVIDING ON THE FLY UPDATES OF THREAT AND HAZARD INFORMATION THROUGH A MOBILE APPLICATION

(71) Applicant: Ramji Venkatachari, Herndon, VA (US)

(72) Inventor: Ramji Venkatachari, Herndon, VA (US)

(21) Appl. No.: 14/306,907

(22) Filed: Jun. 17, 2014

Related U.S. Application Data
(60) Provisional application No. 61/835,932, filed on Jun. 17, 2013.

(51) Int. Cl. G08B 27/00; G08B 21/02

(52) U.S. Cl. CPC G08B 27/008; G08B 21/02
USPC 340/539.13

(57) ABSTRACT

The invention provides for a mobile application based solution that promotes threat awareness by utilizing existing blueprints and layout of a building. Users of the system who identify a threat can use the system to notify others within the school or organization of the threat and the location of the threat, as well as use the system to contact local authorities. These on the fly updates of where threats have been identified can be used in planning escape routes.

### RELATED APPLICATION

This application claims priority to U.S. Provisional Patent Application 61/835,932 filed on Jun. 17, 2013, entitled “System And Method For Providing On The Fly Updates of Threat And Hazard Information Through A Mobile Application”, the entirety of which is incorporated herein.

### BACKGROUND OF THE INVENTION

1. Field of the Invention

The present invention relates generally to the field of mobile applications. More specifically to using mobile applications to promote threat awareness.

2. Description of the Related Art

The use of mobile phones has grown dramatically from a device simply capable of making and receiving calls into a device capable of performing a plethora of non-call making/receiving related functions. These non-call making/receiving functions are usually accomplished through the use of mobile applications. Although there are countless mobile applications designed to perform these non-call making/receiving related functions, there is a need for mobile applications that are capable of promoting threat awareness.

Unfortunately, schools, offices and public venues around the world are becoming a target to foreign and domestic terrorism. There are not enough law enforcement officers available to secure every location where a terrorist or terrorist organization may attack. Currently, information relevant to a threat is generic and disseminated in broadcast form. Such information is typically from news and information sources, is disseminated after some delay, and is focused on a general location applicable to a wide audience. However, those in close proximity of the threat need immediate information, need assistance on ways to best protect themselves and other innocent people, and don't want it broadcast widely.

Therefore, what is needed is a system with a user interface that is flexible and user friendly, and which can promote threat awareness by providing a tool that notifies people, such as employees, within an organization when a threat is identified, as well as on the fly update of where threats have been identified for the purpose of planning escape routes.

### SUMMARY OF THE INVENTION

This summary of the invention is provided to introduce concepts in a simplified form that are further described in the detailed description of the invention. This summary is not intended to identify key or essential inventive concepts of the claimed subject.

The present invention provides a system, method, and solution for the promotion of threat awareness, notification to employees within an organization or individuals within a location when a threat is identified, and on the fly updates of where threats have been identified for the purposes of planning escape routes. An organization or the location could be Schools, Offices, Sports Arenas, or other Public Venues where people congregate such as Movie Theaters, Train Stations, Airports, and Shopping Malls (collectively hereinafter referred to as an “organization”). The threat and hazard response system uses various processors, servers, software, and communication devices in combination with mobile applications on smart phone devices, such as Android and iPhone devices, to provide relevant threat information.

The threat and hazard response system provides a mobile application in combination with various servers, processors, computing devices and networks to provide organizations with threat and hazard information, in addition to providing similar information to first responders who can be used to plan escape routes and aid in rescues. The threat and hazard response system provides teachers, employees, maintenance staff, grounds keepers, etc. with information in which to assist the user keep their organization safe. The information may be provided in one or more software modules within the mobile software application and may provide information such as a map of the building, escape or exit routes, as well as provide information on various safety checks and reports. The system may allow users to “LOOK” and identify things that seem out of the norm, or “REPORT” incidents in a timely and accurate manner, and “RESPOND” to active threats if your organization, campus, or workplace becomes engaged by a threat or crisis situation.

Users in an organization that utilize the threat and hazard response system make use of the mobile application on their smartphone devices such as Android and iPhone devices. The mobile application and related system software is designed such that in an emergency, the more personnel within the organization and response network that are aware of the situation the better the opportunity for more information to be shared. Thus, more real time information is available to provide an accurate picture of the situation. The response network includes police, fire and rescue, and other local and national authorities that may be involved in the response.

All users of the threat and hazard response system mobile app have to do is identify their organization and their building's blueprint and layout can be identified, and the system will incorporate that information into what will become the layout or a main user interface screen of the mobile application. The user interface of the threat and hazard response system mobile app is flexible and extremely user friendly.

The system of the present invention utilizes a zone based identification rather than specific rooms. Users of the threat and hazard response system mobile app are able to tap a Zone on their own floor plan and send out one of several alerts based on the severity of the threat. The primary or initial three alert types are: All Clear, Suspicious Activity or Immediate Threat. Other “super” authorized users of the system within the organization will be notified and will be able to see on their mobile phones all the alerts on their floor plan maps. Users within a school or organization who touch an alert on the screen of their mobile phone will be presented with information regarding that alert such as the timestamp of when the alert was posted, as well as the user who made the alert. Based on the severity of the threat, certain users will be able to immediately dial 911 from within the threat and hazard response system mobile app or have the app contact 911 automatically.

These and other objects, features, and/or advantages may accrue from various aspects of embodiments of the present invention, as described in more detail below.

### BRIEF DESCRIPTION OF THE DRAWINGS

Various exemplary embodiments of this invention will be described in detail, wherein like reference numerals refer to identical or similar components or steps, with reference to the following figures, wherein:

FIG. 1 depicts a system diagram of the present invention;

FIG. 2 depicts a user interface screen showing the map and zone function of the present invention;

FIG. 3 depicts a user interface screen showing the panic timer function of the present invention.

### DETAILED DESCRIPTION OF EXEMPLARY EMBODIMENTS

Particular embodiments of the present invention will now be described in greater detail with reference to the figures. Like reference numerals apply to similar parts throughout the several views. The embodiments presented here are not meant to be exhaustive. Other embodiments using the concepts introduced in the present invention are possible. In addition, the components in these embodiments may be implemented in a variety of different ways.

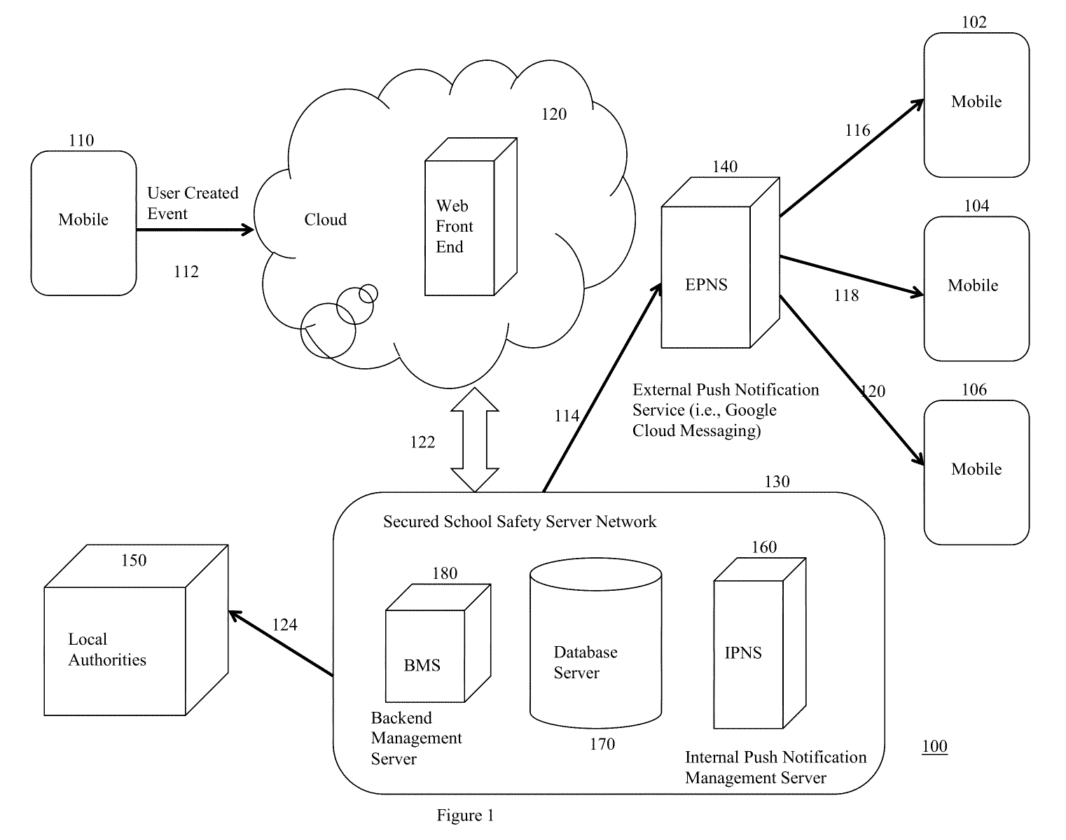

As seen in FIG. 1, the present invention can provide a threat notification system 100 where the user of the threat and hazard response system mobile app on their mobile device 110 can create one of several alerts to notify others of a perceived threat. The mobile device 110 can be a mix of Android and/or iOS devices or a Blackberry or a Windows mobile smartphone. The three alert types are: All Clear, Suspicious Activity, and Immediate Threat. The alert created by the mobile device 110 is communicated to the Cloud 120 via communication path 112. The communication may be through Wi-Fi, network carrier of the mobile device, or a combination of any such paths. The alert is then transmitted to the Secured School Safety Server Network 130 via communication path 122. The communication may be through a router, Wi-Fi, Bluetooth, NFC, any other mechanism, or a combination of any such paths. The Secured School Safety Server Network then communicates the alert to the External Push Notification Service (EPNS) 140 via communication path 114. The communication may be through an Internal Push Notification Management Server. EPNS 140 communicates the alert to mobile devices 102, 104, 106 via communication paths 116, 118, 120. The communication may, for example, be through Google Cloud Messaging.

In one embodiment of the present invention, the user of the threat and hazard response system mobile app on their mobile device 110 that notifies others of a perceived threat must be within the pre-determined Geo-Fence Zone. Administrators of the system may define the perimeter of the event via Geo-Fence mapping. The zone may include the building, stadiums, practice fields and all other locations considered part of the campus. Geo-Location features detect devices within the event grounds, allowing designated users to post alerts only while they are within the Geo-Fence boundaries. Administrators can define their own range of alert posting criteria to ensure that alerts are handled according to their security priority and protocol. The GPS location of any registered users device 102, 104, 106, 110 can be tracked within the Geo-Fence perimeter using wireless carrier towers, Wi-Fi, or radio signals.

When the system 100 is notified that there is an active emergency, the system 100 will send a push notification to the user's mobile device 102, 104, 106. Users with an Android mobile device that contains Google Cloud Messaging will receive an automatic push notification regardless as to whether the system's mobile app is in the foreground, background or inactive. This message will be passed from the system's EPNS 140 via communication paths 116, 118, 120 as raw JSON data into the mobile app's background service. Users will have the option to allow the mobile app to post a notification to the notification bar and/or initiate a synchronization action where the real-time information will be upload to the mobile app regarding the present emergency.

If the user has an iOS mobile device 102, 104, 106 with Apple Push Notification Service, the alert notification method will depend upon whether the mobile app is in the background, foreground, or inactive. If the mobile app is not in the foreground, the system 100 will display the notification informing the user that updated information is available via an alert, icon badge number, and/or sound. This alert can be displayed as an alert message or can badge the mobile app icon when new information is received. In addition to the visual notification, the system can alert the user by playing a sound to inform him or her that new information has been received. The user can tap the action button, thus launching the application, in order to provide the user the newly updated information. If the mobile app is running in the foreground when the notification is delivered, the user will receive a local or push notification based upon the pre-determined preferences set by that user. For example the user can elect that the notification be in the form of a banner or an alert message.

The system 100 also has the capability to override the mobile device's current settings. For example, when there is an active emergency with apparent life threatening conditions, the application may override the device's 102, 104, 106 silent or vibrate setting so that the user will hear the alert. This override capability will be automatically activated unless the user opts out through the mobile app's internal settings page.

In an alternative embodiment of the present invention, the system can utilize the government's alert network, the Wireless Emergency Alerts system, to disseminate emergency messages to the user's mobile device located within the zone of an emergency. These notifications can come as an SMS message, telephone call or a push notification.

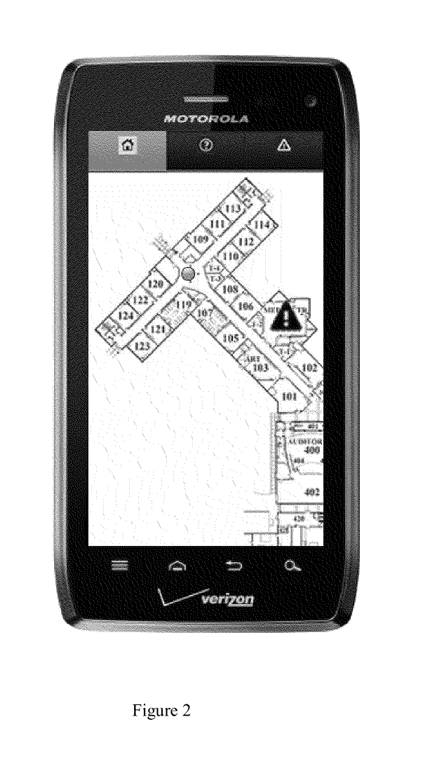

As seen in FIG. 2, users of the present invention, such as for example within a school or organization, will be notified and will be able to see on their mobile smartphones all the alerts on their floor plan maps. As the alerts become old, they will fade off of the zone map. Fading is based on two factors: Alert Type and Organization Preference. In terms of alert types, for example, all clear alerts should fade faster than suspicious activity alerts, and suspicious activity alerts should fade faster than immediate threat alerts. In terms of organization preference, organizations will be able to define a factor in determining when alerts fade. The idea of fading or aging an alert is used to ensure that information is kept current, and not stale.

Users with the mobile devices 102, 104, 106 who touch an alert on the screen of their mobile device will be presented with information regarding that alert created by the user of mobile device 110 such as the timestamp of when the alert was posted, and the user who made the alert. If the alert created by the user of mobile device 110 is Suspicious Activity, users with mobile devices 102-106 will receive a “Buzz,” i.e., their phone vibrates twice to alert them that something may be going on, without causing undue attention to others. Only the user with mobile device 110 who created the alert, or anyone in the “Emergency Contact” role can disable suspicious Activity alerts.

However, if the alert created by the user of mobile device 110 is an Immediate Threat alert, users with mobile devices 102, 104, 106 will receive a continuous “Buzz,” i.e., their phone vibrates, or repeats on periodic intervals, until acknowledged, so as to make all personnel aware that a situation has been identified. Users with mobile devices 102, 104, 106 that have been assigned to the “Emergency Contact” role will receive a popup notification on the screen of the mobile device with a button to immediately dial 911. The popup notification will contain as much information as is possible such as the timestamp of when the Immediate Threat was identified, the user with the mobile device 110 who made the Immediate Threat alert, and the zone the Immediate Threat was identified in. Only users with the mobile devices 102, 104, 106 who are assigned to the “Emergency Contact” role can remove Immediate Threat alerts.

Users of mobile devices 110, 102, 104, and 106 will also have access to various menu options that provide local emergency contact information, threat and hazard response system information, and information about how to respond. Local emergency information will consist of information such as the local police department, the fire department, and EMS. The threat and Hazard response system information contains general reference information about the threat and hazard response system such as the product version, support information, and related information.

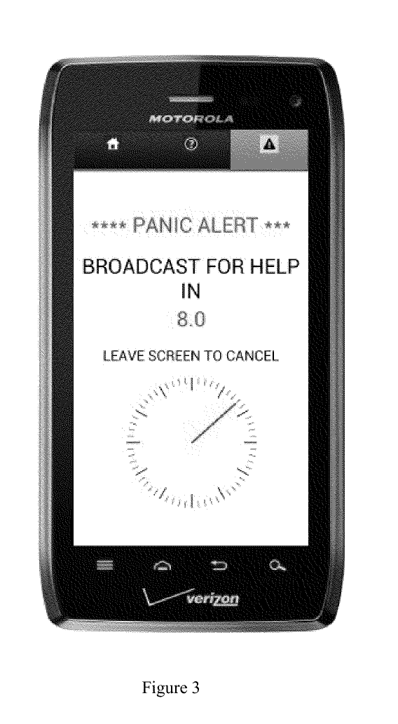

In addition to the three alerts option (All Clear, Suspicious Activity, and Immediate Threat), the user of mobile device 110 who initiates an alert will also have access to a one-touch icon that starts a PANIC timer, as seen in FIG. 3, and converts the app into Panic Mode. The PANIC timer is defined by the school or organization. The timer can be cancelled only by the user with mobile device 110 who created it. Once the timer reaches ZERO, an Immediate Threat alert is dispatched to mobile devices 102, 104, 106 without zone information so as to not provide information to any illicit individual(s). Users with mobile devices 102, 104, 106 will receive a popup on the screen of their mobile device with the name of the user of the mobile device 110 who activated the PANIC timer. The threat and hazard response system app then locks itself on the “Help & Information” screen. This lock mechanism is designed to prevent the illicit individual(s) who pose or caused the hazard or threat from getting a hold of a device that has been placed in panic mode and being able to see the location of other users of the threat and hazard response system with devices 102, 104, 106 within the organization. The lock mechanism also prevents the illicit individual(s) from being able to see that the device has been placed into a panic mode. Unlocking the threat and hazard response system app from the panic mode requires a specific feature such as uninstalling and reinstalling of the threat and hazard response system app, or specific touch and swipe gestures on the help screen. The panic mode serves two very important purposes: it provides a method that requires almost no interaction, i.e., once a timer has been started, the user of the mobile device 110 who initiated the panic timer can either drop, pocket, hide, or ignore the device. In addition, the panic mode alerts the users of mobile devices 102, 104, 106 that someone is in PANIC mode, thus making everyone aware and able to start taking action such as making alerts based on their surroundings. Implementation of the timer is useful in case a user accidentally enters Panic Mode because if the app is open, having a one-touch panic mode can create too many false alarms that could be costly to an organization. The timer allows the user to “set it and forget it” in the event of a threat, or provides an added protection in that it notifies a user who accidentally set off panic mode, and the user can cancel the timer prior to it reaching ZERO, thus preventing a false alarm. Another feature particular to the timer is that it causes the panic mode screen to gradually fade to black as it counts down to ZERO. Allowing the panic mode screen to gradually fade to black helps to prevent incidents where bad guys may see the panic mode hit. Black also serves as an added incentive in that it will not draw attention to mobile devices 102, 104, 106 since the screen will slowly stop being lit up. In addition, once the screen completely fades to black, the threat and hazard response system app automatically switches to the “Help & Information” screen, and that is the only functionality that is still enabled. The “Home” and “Panic” tab are both removed. At this point, the threat and hazard response system app appears to be nothing more than an informative application, and appear as harmless as possible to the illicit individual(s) who created or pose the threat.

The present invention may use global positioning satellite (GPS) information to tag alerts with as accurate a location as possible. Further, a way to conserve battery life, the system may only begin getting an update of the immediate threat information when the user is on the home screen or on the Panic Mode screen, and update that information only if it is older than a preset time period (i.e. 2 minutes). The system may use the GPS coordinates to attempt to automatically locate which zone the user is in. The system may also use the GPS and client calibrated information to attempt to place the user on a specific floor at the organization, based on the altitude information returned from the GPS.

The system may also make use of an audio recording feature available within the mobile device which may be activated when an Immediate Threat is identified-or-Panic Mode is enabled, the device will automatically begin recording via the built in microphone. The audio recording from the device within the Geo Fence will be simultaneously uploaded on-the-fly directly to the cloud-based server, thus creating a “black box” that can allow administrators, first responders, local authorities, attorneys, courts, and other parties to review information from the scene without the user having to take any additional action.

The system may also make use of a video recording feature available within the mobile device which may be activated via one button or automatically when an Immediate Threat is identified-or-Panic Mode is enabled. The video is simultaneously uploaded on-the-fly to the cloud-based server, once again allowing for further evidence regarding the incident to be made available. For example, video of the emergency event can be streamed from a registered device within the Geo Fence to the Crisis Watch Center, to first responders, district administrators and other authorized users.

The system utilizes or makes available to its users the floor plans of their organization. The system can then overlay planned evacuation routes for each zone onto the map. The display of this information could be similar to the emergency exit notification lights in airplanes or direction routes provide on typical web based applications such as www.mapquest.com. This allows for the user to make best judgment call on which evacuation route to take based on identified threat information. In one embodiment, the system can utilize Google maps and layer the evacuation route datasets and other pertinent datasets onto the map.

The system also employs a rescue me mode for instances in which the user becomes trapped. The “Rescue Me” mode activates the GPS on limited time basis (to conserve battery) until an accurate location is established. The rescue mode then has the device 102, 104, 106 notify the server 180 and other users of the location of the device of the user in need of rescue. In a preferred embodiment, once the location of the device is obtained (within 10 meters), further GPS updates are not needed as it is assumed the user is not moving very far. The system can also activate a flashlight or strobe light mode (if device has a built-in camera with a flash) for limited periods of time.

The system of the present invention is capable of receiving events that request the device to make audible noise such that if the user is no longer conscious an administrator can remotely make the device sound out an alarm to notify rescue crews of the device's location. The concept of a “beacon” analogy where the device now provides the rescue crew information about the location of the device, therefore the person having the device, even when the person is unable to respond and take any action on their own. A key advantage of the information being published to the server is that even if the device runs out of battery and is no longer able to provide beacon information, the server can provide that information to the rescue personnel.

The system may also employ a Web Based (non-mobile) Command and Control operation system that allows administrators control over the application on all of their user's devices. The system would be able to deactivate the application and prevent it from sending or receiving any further notifications—such as in the event the device falls into the wrong hands. The system has the ability to request GPS location of individual users or all users overlaid on the school's geo-fence and well as the ability to unlock devices that have been locked down due to Panic Mode. Furthermore the system has the ability to track first responder vehicles to assist with infiltration and staging activities.

The system can further integrate the backend servers to other services such as the National Weather Service to receive local updates regarding storms and severe weather conditions. Therefore, the system using the application's built-in notification system can send National Weather Service alerts directly to the device.

The system 100 can further provide training and preparedness drills for users. Through the system 100, schools can carry out specialized training drill on a yearly, quarterly or monthly basis. These drills may include first responders and emergency personnel.

The examples provided herein are merely for the purpose of explanation and are in no way to be construed as limiting of the present method and product disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention expands to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

It will be recognized by those skilled in the art that changes or modifications may be made to the above-described embodiment without departing from the broad inventive concepts of the invention. It is understood therefore that the invention is not limited to the particular embodiment, which is described, but is intended to cover all modifications and changes within the scope and spirit of the invention.

I claim:

1. A system for providing real time threat information to a mobile device, comprising:
at least one processor;
a database for storing a plurality of location information including at least one facility plan image; and
a computer-readable storage medium storing one or more sequences of instructions which, when read by the at least one processor, causes the system to:
receive threat information from at least one of a plurality of sources, wherein the threat information includes information on the location of the threat;
identify at least one mobile device within a defined range of the location of the threat;
identify the type of mobile device and a message type associated with each of the identified mobile devices;
initiate a push transmission from the at least one processor to the mobile device with the threat information using the identified message type;
displaying the at least one facility plan image on the user interface of the mobile device; and
displaying the location of the threat on the facility plan image.

2. The system of claim 1, wherein the facility plan image is a school floor plan.

3. The system of claim 1, wherein the at least one of a plurality of sources for receiving threat information is other users through their mobile device.

4. The system of claim 1, wherein the push transmission is sent to a mobile client on the mobile device.

5. The system of claim 4, wherein the threat information is retrieved from the at least one processor by the mobile client.
